(19) United States
(12) Patent Application Publication
(10) Pub. No.: US 2008/0181329 A1
(43) Pub. Date: Jul. 31, 2008

(54) DATA TRANSMITTING APPARATUS AND DATA RECEIVING APPARATUS

(76) Inventors: Tsuyoshi IKUSHIMA, Nara (JP); Masaru Fuse, Osaka (JP); Satoshi Furusawa, Osaka (JP); Tomokazu Sada, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/951,003

(22) Filed: Dec. 5, 2007

(30) Foreign Application Priority Data
Dec. 20, 2006 (JP) 2006-343110

(51) Int. Cl. H04L 25/34; H04L 25/49

(52) U.S. Cl. 375/286

(57) ABSTRACT

Provided are a data transmitting apparatus and a data receiving apparatus which use a Y-00 protocol and are capable of preventing an eavesdropper's decryption based on a transition pattern of a multi-level signal level. The data transmitting apparatus 101,103 of the present invention includes: a multi-level code generation section 111 for generating, by using predetermined key information 11, a multi-level code sequence 12 in which a value changes so as to be approximately random numbers; and a multi-level signal modulator section 112,125 for generating a converted multi-level signal 23 in accordance with information shared with the receiving apparatus 201,203, the multi-level code sequence 12 and information data 10, modulating the converted multi-level signal 23 in a predetermined modulation method, and outputting a resultant modulated signal 14. The converted multi-level signal 23 is a signal having a plurality of signal point allocations which are different from one another. The multi-level signal modulator section 112,125 switches the plurality of signal point allocations of the converted multi-level signal 23 in accordance with the information 21 shared with the receiving apparatus 201, 203.

### BACKGROUND OF THE INVENTION

1. Field of the Invention

The present invention relates to an apparatus for performing cipher communication in order to avoid interception (such as eavesdropping) by a third party. More specifically, the present invention relates to a data transmitting apparatus and a data receiving apparatus for performing data communication through setting a specific encoding/decoding (modulation/demodulation) method between a legitimate transmitter and a legitimate receiver.

2. Description of the Background Art

Conventionally, in order to perform communication between specific parties, there has been generally adopted a structure for realizing cipher communication by sharing original information (herein after referred to as key information) between transmitting and receiving ends so as to mathematically perform an operation (encoding) and an inverse operation (decoding) of plain text which is information data to be transmitted between the transmitting and receiving ends.

On the other hand, there have been suggested, in recent years, several encryption methods, which positively utilize physical phenomenon occurring on a transmission line. As one of the encryption methods, there is a method called Y-00 protocol for performing the cipher communication by utilizing a quantum noise generated in the transmission line.

FIG. 11 is a diagram showing an exemplary configuration of a conventional transmitting/receiving apparatus using the Y-00 protocol disclosed in Japanese Laid-Open Patent Publication No. 2005-57313. Hereinafter, the configuration and an operation of the conventional transmitting/receiving apparatus disclosed in the Japanese Laid-Open Patent Publication No. 2005-57313 will be described. As shown FIG. 11, the conventional transmitting/receiving apparatus includes a transmitting section 901, a receiving section 902, and a transmission line 910. The transmitting section 901 includes a first multi-level code generation section 911, a multi-level processing section 912, and a modulator section 913. The receiving section 902 includes a demodulator section 915, a second multi-level code generation section 914, and a decision section 916. The eavesdropping receiving section 903 is an apparatus used by an intercepting party, and is not including in the conventional transmitting/receiving apparatus.

First, the transmitting section 901 and the receiving section 902 previously retain first key information 91 and second key information 96, respectively, which are key information having contents identical to each other. Hereinafter, an operation of the transmitting section 901 will be described first. The first multi-level code generation section 911 generates, based on the first key information 91, a multi-level code sequence 92, which is a multi-level pseudo random number series having M digits of values from “0” to “M−1” (M is an integer of 2 or more), by using a pseudo random number generator. The multi-level processing section 912 generates, based on information data 90 and the multi-level code sequence 92 which are to be transmitted to the receiving section 902, a multi-level signal 93 which is a intensity modified signal, by using a signal format described hereinbelow.

FIG. 12 is a diagram showing a signal format used by the multi-level processing section 912. As shown in FIG. 12, in the case where the number of the digits of the values constituting the multi-level code sequence 92 is M, signal intensity of the multi-level code sequence 92 is divided into 2M signal intensity levels (herein after, simply referred to as a level). These 2M levels are made into M pairs (herein after referred to as a modulation pair), and to one level of each of the M modulation pairs, a value “0” of the information data 90 is allocated, and to the other level, a value “1” of the information data 90 is allocated. Generally, the allocation is made such that levels corresponding to the value “0” of the information data 90 and levels corresponding to the value “1” of the information data 90 are evenly distributed over the whole of the 2M levels. In FIG. 12, “0” is allocated to a lower level of an even-numbered modulation pair, and “1” is allocated to a higher level of the same. On the other hand, with respect to an odd-numbered modulation pair, “1” is allocated to a lower level of the odd-numbered modulation pair, and “0” is allocated to a higher level of the same. Accordingly, the values “0” and “1” are alternatively allocated to each of the 2M levels.

The multi-level processing section 912 selects a modulation pair corresponding to each of the values of the multi-level code sequence 92 having been inputted, then selects one level of the modulation pair, the level corresponding to the value of the information data 90, and outputs a multi-level signal 93 having the selected level. The modulator section 913 converts the multi-level signal 93 outputted by the multi-level processing section 912 into a modulated signal 94 which is a light intensity modulated signal, and transmits the modulated signal 94 to the receiving section 902 via the transmission line 910. (Note that, in the Japanese Laid-Open Patent Publication No. 2005-57313, the first multi-level code generation section 911 is described as a “transmitting pseudo random number generation section”, the multi-level processing section 912 as a “modulation method specification section” and a “laser modulation driving section”, the modulator section 913 as a “laser diode”, the demodulator section 915 as a “photo-detector”, the second multi-level code generation section 914 as a “receiving pseudo random number generation section”, and the decision section 916 as a “determination circuit”.)

Next, an operation of the receiving section 902 will be described. The demodulator section 915 converts the modulated signal 94 which is received via the transmission line 910 from a light signal to an electrical signal (herein after referred to as photo-electric conversion) and outputs a resultant signal as a multi-level signal 95. The second multi-level code generation section 914 generates, based on the second key information 96, a multi-level code sequence 97 which is a pseudo random number series constituted of multi levels, and is the same as the multi-level code sequence 92. The decision section 916 determines, based on respective values of the multi-level code sequence 97 inputted by the second multi-level code generation section 914, respective modulation pairs used for the multi-level signal 95. The decision section 916 performs binary decision by using the determined modulation pairs and the multi-level signal 95 inputted by the demodulator section 915, and then obtains information data 98 which is equivalent to the information data 90.

FIG. 13 is a diagram specifically illustrating an operation of the conventional transmitting/receiving apparatus. Hereinafter, with reference to FIG. 13, the operation of the conventional transmitting/receiving apparatus will be described in the case where the number of the digits of the values constituting the multi-level code sequence 92 is 4 (M=4). As shown in (a) and (b) of FIG. 13, an exemplary case will be described where the value of the information data 90 changes “0 1 1 1”, and the value of the multi-level code sequence 92 changes “0 3 2 1”. In this case, a level of the multi-level signal 93 of the transmitting section 901 changes “1 4 7 2” as shown in FIG. 13(c).

Specifically, at a time period t1 shown in FIG. 13(c), a 0th modulation pair corresponding to a value “0” of the multi-level code sequence 92 (a pair of level 1 and level 5) is selected. Thereafter, level 1 of the 0th modulation pair corresponding the value “0” of the information data 90 is selected, and the selected level 1 comes to a level of the multi-level signal 93 at the time period t1. In a similar manner, at a time period t2, a third modulation pair corresponding to a value “3” of the multi-level code sequence 92 (a pair of level 4 and level 8) is selected. Thereafter, level 4 of the third modulation pair corresponding to the value “1” of the information data 90 is selected, and the selected level 4 comes to a level of the multi-level signal 93 at t2. For a time period t3 and a time period t4 as well, a level of the multi-level signal 93 is selected in a similar manner. In this manner, at each of the time periods t1 and t3, in which the value of the multi-level code sequence 92 is even-numbered, the lower level of the modulation pair corresponds to the value “0” of the information data, and the higher level of the modulation pair corresponds to the value “1” of the information data. On the other hand, at each of the time periods t2 and t4, in which the value of the multi-level code sequence 92 is odd-numbered, the lower level of the modulation pair corresponds to value “1” of the information data, and the higher level of the modulation pair corresponds to the value “0” of the information data.

The multi-level signal 95 inputted by the decision section 916 of the receiving section 902 is a signal which changes as shown in FIG. 13(e), and includes noise, such as a shot noise, which is generated through the photo-electric conversion in the demodulation section 915. The decision section 916 selects the respective modulation pairs corresponding to the respective values of the multi-level code sequence 97 (see FIG. 13(d)) which are equal to the values of the multi-level code sequence 92, and sets an intermediate level of each of the modulation pairs as a decision level thereof, as shown in FIG. 13(e). The decision section 916 then determines whether the multi-level signal 95 is higher or lower than the decision level.

Specifically, at a time period t1 shown in FIG. 13(e), the decision section 916 selects the 0th modulation pair (the pair of level 1 and level 5) which corresponds to the value “0” of the multi-level code sequence 97, and sets level 3, which is an intermediate level of the 0th modulation pair, as the decision level. Since the multi-level signal 95 is generally distributed in lower levels than the decision level, the decision section 916 then determines that the multi-level signal 95 is lower than the decision level at t1. In a similar manner, at a time period t2, the decision section 916 selects the third modulation pair (a pair of level 4 and level 8) which corresponds to the value “3” of the multi-level code sequence 97, and sets level 6, which is an intermediate level of the third modulation pair, as the decision level. Since the multi-level signal 95 is generally distributed in lower levels than the decision level at t2, the decision section 916 then determines that the multi-level signal 95 is lower than the decision level at t2. At time periods t3 and t4 as well, decision is made in a similar manner, and accordingly, a result of the binary decision performed by the decision section 916 comes to “lower, lower, higher, lower”.

Next, in the case where the values of the multi-level code sequence 97 are each an even number (in the case of each of the time periods t1 and t3), the decision section 916 determines that a lower level of the selected modulation pair is “0” and that a higher level thereof is “1”, and then outputs the determined values as the information data 98. On the other hand, in the case the values of the multi-level code sequence 97 are each an odd number (in the case of time periods t2 and t4), the decision section 916 determines that a lower level of the selected modulation pair is “1”, and a higher level thereof is “0”, and then outputs the determined values as the information data 98. The values of the multi-level code sequence 97 are “0 3 2 1”, that is, “even, odd, eve, odd” (even representing an even number, and odd representing an odd number). Accordingly, the decision section 916 outputs “0 1 1 1”, which is the information data 98 equal to the information data 90 (see FIG. 13(f)). In this manner, the decision section 916 can obtain the information data 98, based on the multi-level signal 95 which varies the values of the information data to be allocated to the higher level and the lower level of the modulation pair, depending on whether each of the values of the multi-level code sequence 97 is even-numbered or odd-numbered.

The description of the conventional transmitting/receiving apparatus does not illustrate a specific processing method for obtaining each of the values of the information data 98 depending on whether each of the values of the multi-level code sequence 97 is odd-numbered or even-numbered. However, the following processing method is generally used. First, the second multi-level code generation section 914 generates an inverted signal 99 “0 1 0 1” which is a binary signal and corresponds to the lowest bit of each of the values “0 3 2 1” of the multi-level code sequence 97, in the case where the values are each represented in a binary form. The decision section 916 then performs an exclusive OR operation between a signal “0 0 1 0”, which represents “lower, lower, higher, lower” as a result of the above-described binary decision, and the inverted signal 99 “0 1 0 1”. From a result of the operation, the information data 98 “0 1 1 1” is obtained.

As above described, in the case where the signal format is used in which the values of the information data to be allocated to the higher level and the lower level of the modulation pair vary depending on whether each of the value of the multi-level code sequence 97 is odd-numbered or even-numbered (see FIG. 12), the decision section 916 uses the inverted signal 99 so as to generate the information data 98. However, in the case where a signal format is used in which the value “1” of the information data is constantly allocated to the higher level of the modulation pair, and the value “0” of the information data is allocated to the lower level thereof, the decision section 916 does not necessarily use the inverted signal 99 so as to generated the information data 98.

Further, as above described, the multi-level signal 95 includes the noise such as the shot nose which is generated through the photo-electric conversion in the demodulator section 915. However, by setting an interval between the levels (herein after referred to as a step width) appropriately, occurrence of erroneous binary decision may be suppressed to a negligible level.

Next, possible eavesdropping (including interception) will be described. As shown in FIG. 11, an eavesdropper attempts decryption of the information data 90 or the first key information 91 from the modulated signal 94 by using an eavesdropping receiving section 903, without having key information shared between a transmitting party and a receiving party. The eavesdropping receiving section 903 includes a demodulator section 921, a multi-level decision section 922, and a decryption processing section 923, and is connected to the transmission line 910.

In the case where the eavesdropper performs the same binary decision as a legitimate receiving party (receiving section 902), the eavesdropper needs to attempt decision with respect to all possible values which the key information may take since the eavesdropper does not have the key information. However, when this method is used, the number of attempts of the decision increases exponentially in proportion to an increase in a length of the key information. Accordingly, if the length of the key information is significantly long, the method is not practical.

As a further effective method, it is assumed that the eavesdropper performs multi-level decision of the multi-level signal 81 using the multi-level decision section 922, the multi-level signal 81 having been obtained by performing the photo-electric conversion using the demodulator section 921, decrypts the obtained received sequence 82 using the decryption processing section 923, thereby attempting decryption of the information data 90 or the first key information 91. In the case of using such a decryption method, if the eavesdropping receiving section 301 can receive (decide) the multi-level signal 93 as the received sequence 82 without mistake, it is possible to decrypt the first key information 91 using the received sequence 82 at a first attempt.

Since the shot noise generated through the photo-electric conversion in the demodulator section 921 is overlapped on the modulated signal 94, the shot noise is included in the multi-level signal 81. It is known that the shot noise is inevitably generated according to the principle of quantum mechanics. Therefore, if the step width of the multi-level signal 93 is set significantly smaller than a distribution width of the shot noise, the multi-level signal 81 including the noise may be distributed over various levels other than a correct level (the level of the multi-level signal 93). For example, as shown in FIG. 13(g), at t1, the multi-level signal 81 is distributed over levels 0 to 2. Accordingly, the eavesdropper needs to perform decryption in consideration of a possibility (a possibility of erroneous decision) that the level of the received sequence 82 obtained through the decision is different from the correct level. Therefore, compared with a case without the erroneous decision, the number of the attempts, that is, computational complexity, required for the decryption is increased. As a result, security against the eavesdropping improves.

However, in the above-described conventional transmitting/receiving apparatus, since the distribution width of the shot noise generated through the photo-electric conversion is small, levels resulting from erroneous multi-level decision made by the eavesdropper appear only in the vicinity of the level of the multi-level signal 93 (a correct signal). For example, at a time period t2 shown in FIG. 13(g), the level of the multi-level signal 93 is 4, whereas a level which eavesdropper may erroneously take is limited to 3 or 5. Further, since the level of the multi-level signal 93 uniquely corresponds to the multi-level code sequence 92 generated by using the pseudo random number generator, a transition pattern of the level over a plurality of symbols of the time periods do not necessarily range over all possible transition patterns, but is limited to several transition patterns which is determined by a characteristic of the pseudo random number generator used for generating the multi-level code sequence 92.

As a result, a problem is posed in that the eavesdropper extracts, among the limited transition patterns, the transition pattern which exists in the vicinity of the level of the multi-level signal 81 having been received by the eavesdropper, thereby being likely to be able to effectively identify the multi-level signal 93.

### SUMMARY OF THE INVENTION

Therefore, an object of the present invention is to provide a data transmitting apparatus and a data receiving apparatus which use a Y-00 protocol, and are able to prevent an eavesdropper's decryption based on a transition pattern of a multi-level signal level.

The present invention is directed to a data transmitting apparatus for causing information data to have multi levels by using predetermined key information and performing secret communication with a receiving apparatus. To attain the above-described objects, the data transmitting apparatus of the present invention includes: a multi-level code generation section for generating, by using the predetermined key information, a multi-level code sequence in which a value changes so as to be approximately random numbers; and a multi-level signal modulator section for generating a converted multi-level signal in accordance with information shared with the receiving apparatus, the multi-level code sequence and the information data, modulating the converted multi-level signal in a predetermined modulation method, and outputting a resultant modulated signal. The converted multi-level signal is a signal having a plurality of signal point allocations which are different from one another. The multi-level signal modulator section switches the plurality of signal point allocations of the converted multi-level signal in accordance with the information shared with the receiving apparatus.

Preferably, the plurality of signal point allocations may include at least a first signal point allocation and a second signal point allocation each having a plurality of signal levels corresponding to the multi-level code sequence. The first signal point allocation and the second signal point allocation may respectively have polarities which are mutually in an inverted relation, the polarities each representing an ascending/descending order of the plurality of signal levels corresponding to the multi-level code sequence.

Further preferably, the first signal point allocation may be formed based on a first signal format, and the second signal point allocation may be formed based on a second signal format. The first signal format and the second signal format may each represent a signal format which allows values of the information data and the plurality of signal levels to be allocated to the multi-level code sequence, and be mutually in a inverted relation concerning an ascending/descending order of the multi-level code sequence corresponding to the plurality of signal levels.

Further, in the first signal format and the second signal format, common signal levels may be allocated to different values of the information data.

Further, the multi-level signal modulator section may include: a multi-level processing section for generating a multi-level signal by using the information data and the multi-level code sequence in accordance with the first signal format; a switching random number generation section for generating a switching random number, which is constituted of binary random numbers, by using switching key information which is information shared with the receiving apparatus; a signal point allocation switching section for switching, in accordance with the switching random number, the multi-level signal to a multi-level signal based on the second signal format, and outputting a resultant converted multi-level signal; and a modulator section for modulating the converted multi-level signal, and outputting a resultant modulated signal.

Further, the multi-level signal modulator section may include: a multi-level processing section for generating a multi-level signal by using the information data and the multi-level code sequence in accordance with the first signal format; a switching random number generation section for generating a switching random number, which is constituted of binary random numbers, by using switching key information which is the information shared by the receiving apparatus; and a light modulator section for switching the multi-level signal, which is an electrical signal, to a multi-level signal partially based on the second signal format in accordance with the switching random number and for modulating a resultant signal into a modulated signal which is a light signal. The light modulator section may has at least two different input level ranges respectively corresponding to output level ranges of a common level, the at least two different input level ranges showing opposite increase/decrease characteristics of the corresponding output level ranges in proportion to increases in respective inputs, and use the two input level ranges in a switched manner in accordance with the switching random number.

Further, the light modulator section may include: a polarity inverted signal generation section for converting the switching random number to a polarity inverted signal having two different voltage levels; a semiconductor laser for outputting a non-modulated light; and a Mach-Zehnder light modulator for modulating the non-modulated light by using the multi-level signal and the polarity inverted signal and outputting a resultant modulated signal. A difference between the two voltage levels of the polarity inverted signal is approximately equalized with a half wavelength voltage of the Mach-Zehnder light modulator, whereby the multi-level signal may be switched to a multi-level signal based on the second signal format.

Further, the multi-level signal and the polarity inverted signal may be combined together, and inputted to a single modulating electrode of the Mach-Zehnder light modulator.

Further, the Mach-Zehnder light modulator may have two modulating electrodes corresponding to respective channels of an interferometer provided thereinside. The multi-level signal may be inputted to one of the two modulating electrodes, and the polarity inverted signal may be inputted to the other of the two modulating electrodes.

Further, the multi-level signal modulator section may include: a switching random number generation section for generating a switching random number, which is constituted of binary random numbers, by using switching key information which is the information shared with the receiving apparatus; a code switching section for converting a code of the multi-level code sequence in accordance with the switching random number, and outputting a resultant converted multi-level code sequence; a multi-level processing section for generating, by using the information data and the converted multi-level code sequence, the converted multi-level signal, in accordance with a signal format in which values of the information data and the plurality of signal levels are allocated to the converted multi-level code sequence; and a modulator section for modulating the converted multi-level signal in a predetermined modulation method, and outputting a resultant modulated signal. When the code of the multi-level code sequence is converted, sums between respective values of the multi-level code sequence and respective values of the converted multi-level code sequence may be each constantly equal to a sum between a maximum value and a minimum value of the multi-level code sequence.

Further, the multi-level code sequence may be a binary parallel signal. The code switching section may include: exclusive OR circuits whose number is equal to a number of bits of the respective values constituting the multi-level code sequence; and a D/A conversion section for collectively performing D/A conversion of output signals from the exclusive OR circuits, and outputting the converted multi-level code sequence. The exclusive OR circuits may each perform an exclusive OR operation between respective bits of the respective values constituting the multi-level code sequence and the switching random number, and output a result thereof.

Further, the present invention is directed to a data receiving apparatus for reproducing, by using predetermined key information, information data from a modulated signal having been received, and performing secret communication with a transmitting apparatus. To attain the above-described object, the data receiving apparatus includes: a multi-level code generation section for generating, by using the predetermined key information, a multi-level code sequence in which a value changes so as to be approximately random numbers; a demodulator section for demodulating the modulated signal and outputting a converted multi-level signal; and a signal reproducing section for reproducing the information data in accordance with information shared with the transmitting apparatus, the multi-level code sequence and the converted multi-level signal. The converted multi-level signal is a signal having a plurality of signal point allocations which are different from one another. The signal reproducing section switches the plurality of signal point allocations of the converted multi-level signal in accordance with the information shared with the transmitting apparatus.

Preferably, the plurality of signal point allocations may include at least a first signal point allocation and a second signal point allocation each having a plurality of signal levels corresponding to the multi-level code sequence. The first signal point allocation and the second signal point allocation may respectively have polarities which are mutually in an inverted relation, the polarities each representing an ascending/descending order of the plurality of signal levels corresponding to the multi-level code sequence.

Further, the first signal point allocation may be formed based on a first signal format, and the second signal point allocation may be formed based on a second signal format. The first signal format and the second signal format may each represent a signal format which allows values of the information data and the plurality of signal levels to be allocated to the multi-level code sequence, and be mutually in a inverted relation concerning an ascending/descending order of the multi-level code sequence corresponding to the plurality of signal levels.

Further, in the first signal format and the second signal format, common signal levels may be allocated to different values of the information data.

Further, the signal reproducing section may include: a switching random number generation section for generating a switching random number, which is constituted of binary random numbers, by using switching key information which is the information shared with the transmitting apparatus; a signal point allocation switching section for switching the converted multi-level signal to a signal based on the first signal format in accordance with the switching random number, and outputting a resultant multi-level signal; and a decision section for performing binary decision of the multi-level signal in accordance with the multi-level code sequence, and outputting a resultant signal as the information data.

Further, the signal reproducing section may include: a switching random number generation section for generating a switching random number, which is constituted of binary random numbers, by using switching key information which is the information shared with the transmitting apparatus; a code switching section for converting a code of the multi-level code sequence in accordance with the switching random number, and outputting a resultant converted multi-level code sequence; and a decision section for performing, by using the converted multi-level code sequence, the binary decision of the converted multi-level signal in accordance with a signal format in which values of the information data and the plurality of signal levels are allocated to the converted multi-level code sequence. When the code of the multi-level code sequence is converted, sums between respective values constituting the multi-level code sequence and respective values constituting the converted multi-level code sequence may be each constantly equal to a sum between a maximum value and a minimum value of the multi-level code sequence.

Further, the multi-level code sequence is a binary parallel signal. The code switching section may include: exclusive OR circuits whose number is equal to a number of bits of the respective values constituting the multi-level code sequence; and a D/A conversion section for collectively performing D/A conversion of output signals from the exclusive OR circuits, and outputting the converted multi-level code sequence. The exclusive OR circuits may each perform an exclusive OR operation between respective bits of the respective values constituting the multi-level code sequence and the switching random number, and output a result thereof.

Further, the present invention is directed to a light modulator apparatus for modulating a multi-level signal, which is an electric signal having a plurality of levels, to a modulated signal, which is an optical signal, in accordance with a switching random number which is constituted of binary random numbers. To attain the above-described object, the light modulator apparatus of the present invention includes at least two different input level ranges respectively corresponding to output level ranges of a common level. The at least two input level ranges show opposite increase/decrease characteristics of the corresponding output level ranges in proportion to increases in respective inputs, and are used in a switched manner in accordance with the switching random number.

Further, the light modulator apparatus may include: a polarity inverted signal generation section for converting the switching random number to a polarity inverted signal having two different voltage levels; a semiconductor laser for outputting a non-modulated light; and a Mach-Zehnder light modulator for modulating the non-modulated light by using the multi-level signal and the polarity inverted signal, and outputting a resultant modulated signal. A difference between the two voltage levels of the polarity inverted signal is approximately equalized with a half wavelength voltage of the Mach-Zehnder light modulator, whereby signal point allocation of the multi-level signal may be switched.

Further, the multi-level signal and the polarity inverted signal may be combined together, and inputted to a single modulating electrode of the Mach-Zehnder light modulator.

Further, the Mach-Zehnder light modulator may have two modulating electrodes corresponding to respective channels of an interferometer provided thereinside. The multi-level signal may be inputted to one of the two modulating electrodes, and the polarity inverted signal may be inputted to the other of the two modulating electrodes.

Further, the present invention is directed to a data transmitting method for causing information data to have multi levels by using predetermined key information and performing secret communication with a receiving apparatus. To attain the above-described object, the data transmitting method of the present invention includes the steps of: generating, by using the predetermined key information, a multi-level code sequence in which a value changes so as to be approximately random numbers; and generating a converted multi-level signal in accordance with information shared with the receiving apparatus, the multi-level code sequence and the information data, modulating the converted multi-level signal in a predetermined modulation method, and outputting a resultant modulated signal. The converted multi-level signal is a signal having a plurality of signal point allocations which are different from one another. The plurality of signal point allocations of the converted multi-level signal are switched in accordance with the information shared with the receiving apparatus.

Further, the present invention is directed to a data receiving method for reproducing, by using predetermined key information, information data from a modulated signal having been received and performing secret communication with a transmitting apparatus. To attain the above-described object, the data receiving method of the present invention includes the steps of: generating, by using the predetermined key information, a multi-level code sequence in which a value changes so as to be approximately random numbers; demodulating the modulated signal and outputting a converted multi-level signal; and reproducing the information data in accordance with the information shared with the transmitting apparatus, the multi-level code sequence and the converted multi-level signal. The converted multi-level signal is a signal having a plurality of signal point allocations which are different from one another. The plurality of signal point allocations of the converted multi-level signal are switched in accordance with the information shared with the transmitting apparatus.

As above described, according to the data transmitting apparatus and the data receiving apparatus (data communication apparatus) of the present invention, it is possible to significantly displace a signal intensity level of the multi-level signal by randomly using a plurality of signal formats. Therefore, it is possible to complicate narrowing down of the key information by using the transition pattern of the multi-level signal level, and to improve security against the eavesdropping.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an exemplary configuration of a data communication apparatus 1 according to a first embodiment;

FIG. 2 is a diagram showing exemplary signal formats used by a transmitting section 101 and a receiving section 201;

FIG. 3 is a diagram specifically illustrating an operation of the transmitting section 101 provided in the data communication apparatus 1;

FIG. 4 is a diagram specifically illustrating an operation of the receiving section 201 provided in the data communication apparatus 1;

FIG. 5 is a diagram showing another exemplary signal format used by the transmitting section 101 and the receiving section 201;

FIG. 6 is a diagram showing a multi-level signal modulator section 125 in which a first signal point allocation switching section 115 and a modulator section 116 provided in the multi-level signal modulator section 112 according to the first embodiment are exemplified by specific apparatuses;

FIG. 7 is a diagram showing a general input/output characteristic of a Mach-Zehnder light modulator;

FIG. 8 is a diagram showing another configuration of the multi-level signal modulator section 125;

FIG. 9 is a block diagram showing an exemplary configuration of a data communication apparatus 3 according to a third embodiment;

FIG. 10 is a diagram showing a configuration of a first code switching section 131;

FIG. 11 is a diagram showing an example of a conventional transmitting/receiving apparatus using a Y-00 protocol which is disclosed in Japanese Laid-Open Patent Publication No. 2005-57313;

FIG. 12 is a diagram showing an exemplary signal format used by a multi-level processing section 912; and

FIG. 13 is a diagram specifically showing an operation of the conventional transmitting/receiving apparatus.

### DESCRIPTION OF THE PREFERRED EMBODIMENTS

### First Embodiment

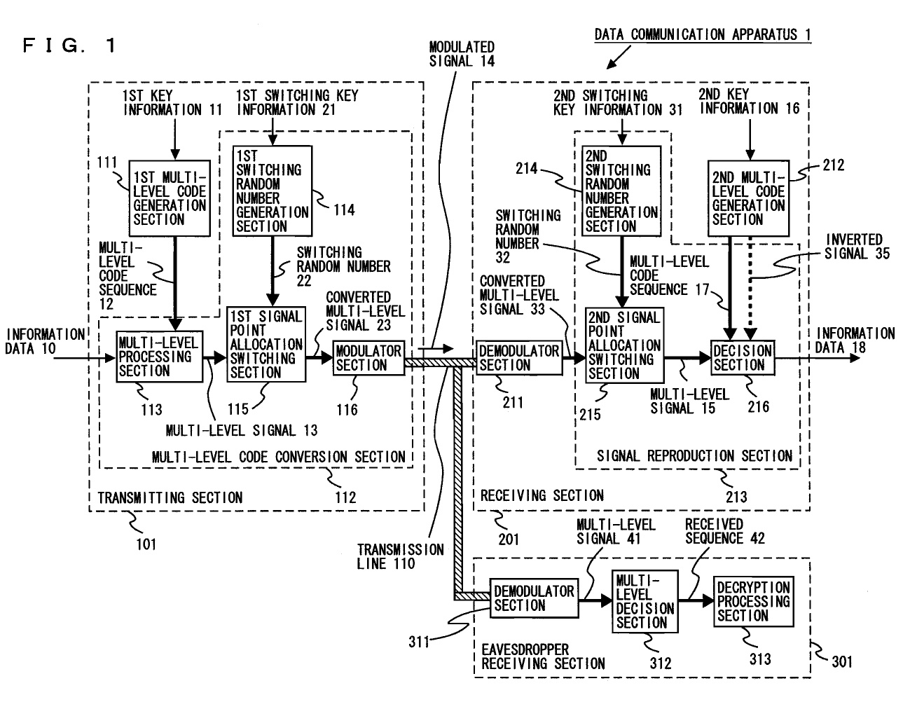

FIG. 1 is a block diagram showing an exemplary configuration of a data communication apparatus 1 according to a first embodiment of the present invention. As shown in FIG. 1, the data communication apparatus 1 has a configuration in which a data transmitting apparatus (herein after referred to as a transmitting section) 101 and a data receiving apparatus (herein after referred to as a receiving section) 201 are connected to each other via a transmission line 110. The transmitting section 101 includes a first multi-level code generation section 111, a multi-level processing section 113, a first switching random number generation section 114, a first signal point allocation switching section 115, and a modulator section 116. The receiving section 201 includes a demodulator section 211, a second multi-level code generation section 212, a second switching random number generation section 214, and second signal point allocation switching section 215, and a decision section 216. As the transmission line 110, a metal line such as a LAN cable and a coaxial cable, or a light waveguide such as an optical-fiber cable may be used. Further, without limiting to these wired cables, free space which enables a wireless signal to be transmitted may be used. Further, the eavesdropping receiving section 301 is an apparatus used by an eavesdropper, and is not included in the data communication apparatus 1.

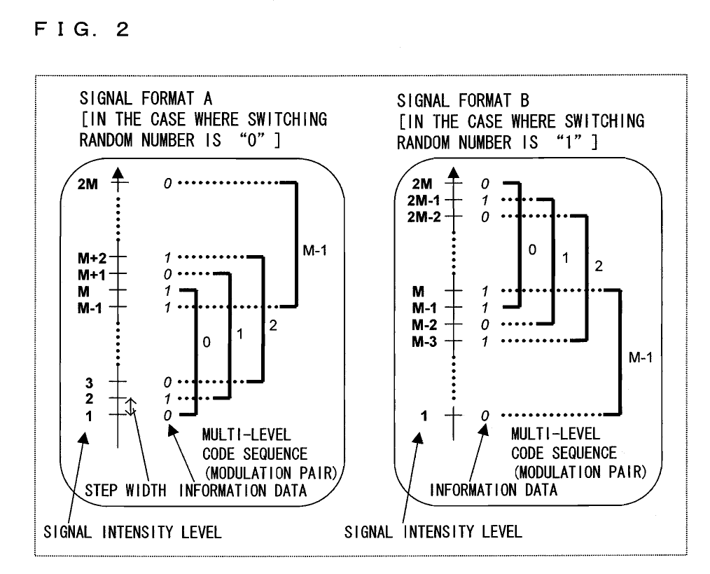

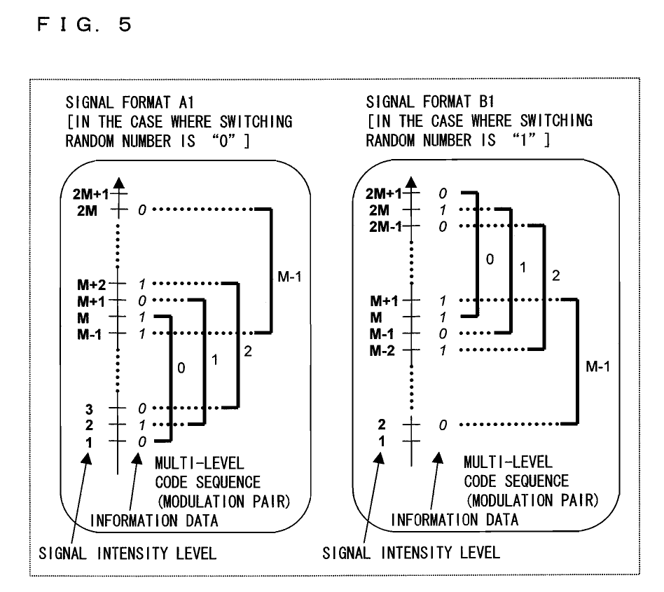

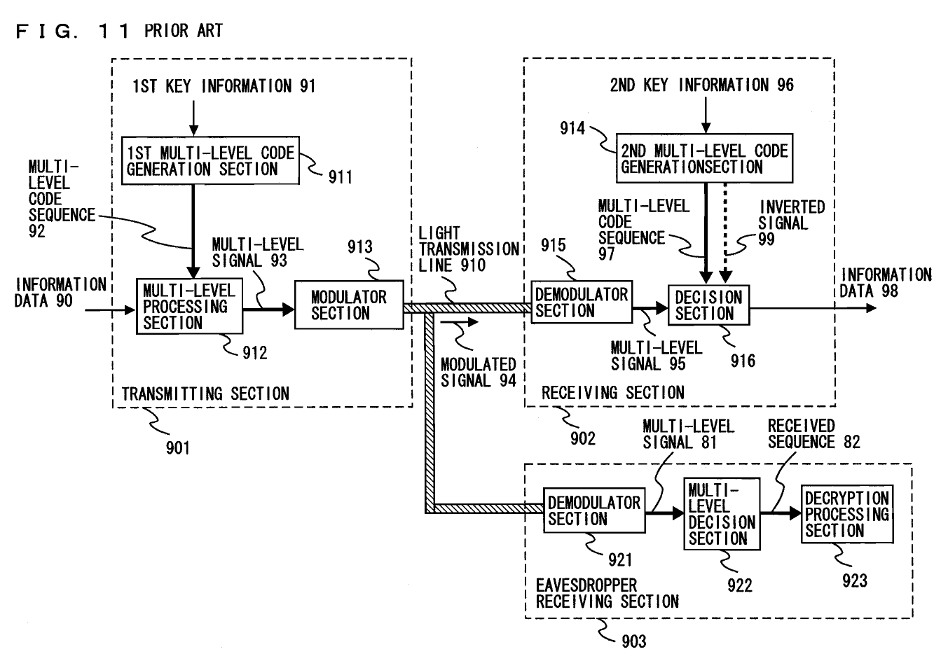

First, the transmitting section 101 and the receiving section 201 previously retain first key information 11 and second key information 16, respectively, which are key information identical in content to each other. The transmitting section 101 and the receiving section 201 also previously retain first switching key information 21 and second switching key information 31, respectively, which are key information identical in content to each other. The transmitting section 101 and the receiving section 201 also retain signal formats, respectively, which are described hereinbelow by using FIGS. 2 and 5 as examples. Hereinafter, an operation of the transmitting section 101 will be described. In the same manner as a conventional first multi-level code generation section 911 (see FIG. 11), the first multi-level code generation section 111 generates a multi-level code sequence 12, which is a multi-level pseudo random number series having M digits of values from “0” to “M−1” (M is an integer of 2 or more), in accordance with the first key information 11 and by using a pseudo random number generator. Regarding a signal mode, the multi-level code sequence 12 may be a multi-level serial signal, or may be a binary parallel signal.

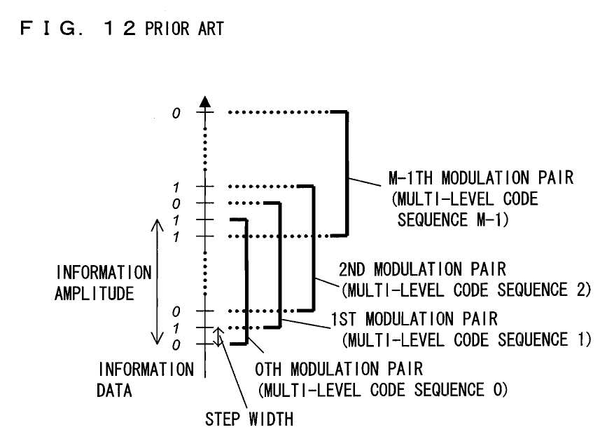

Here, the signal format retained and used by each of the transmitting section 101 and the receiving section 201 will be described. FIG. 2 is a diagram showing exemplary signal formats used by the transmitting section 101 and the receiving section 201, respectively. As shown in FIG. 2, the signal format A is the same as a signal format (see FIG. 12) described with respect to the conventional transmitting/receiving apparatus, where as the signal format B is a signal format which is obtained by inverting an order of values of the multi-level code sequence, with respect to the signal format A, from an ascending order to a descending order. That is, in the signal format A, levels and the values of the multi-level code sequence are both arranged in the ascending order, and in the signal format B, the levels are arranged in the ascending order, whereas the values of the multi-level code sequence are arranged in the descending order.

The signal format A and the signal format Bare not limited to those shown in the drawing. One of the signal formats may be such that the levels and the values of the multi-level code sequence are arranged in a common ascending/descending order, whereas the other signal format may be such that the levels and the values of the multi-level code sequence are arranged in mutually opposite ascending/descending orders. Here, a signal format in which the levels and the values of the multi-level code sequence are arranged in the common ascending/descending order, as with the signal format A, and a signal format in which the levels and the values of the multi-level code sequence are arranged in mutually opposite ascending/descending orders, as with the signal format B, are herein after referred to as being opposite to each other with respect to polarity of the signal formats.

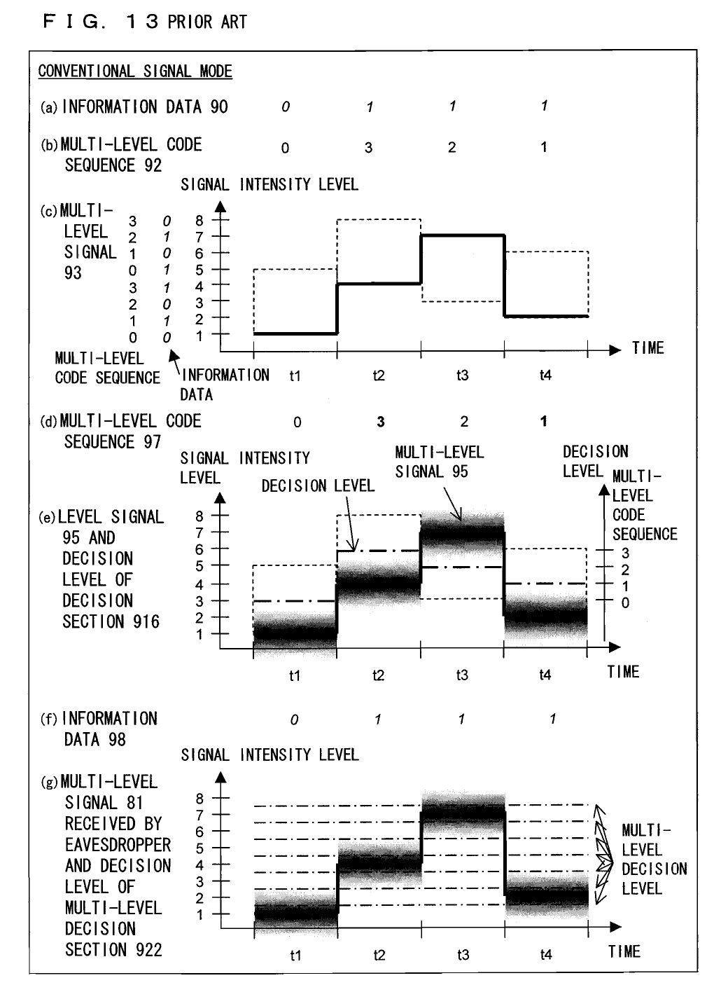

The multi-level processing section 113 performs a processing, which is similar to that of the multi-level processing section 912 of the conventional transmitting/receiving apparatus (see FIG. 11, (a), (b), (c) of FIG. 13 and descriptions thereof), by using the signal format A shown in FIG. 2. That is, the multi-level processing section 113 selects a modulation pair corresponding to inputted values of the multi-level code sequence 12, select one level of the modulation pair which corresponds to a value of information data 10 having been inputted, and outputs the multi-level signal 13 having the selected level.

The first switching random number generation section 114 generates, based on the first switching key information 21, a switching random number 22 which is a binary pseudo random number series. In the case where the value of the inputted switching random number 22 is “1”, the first signal point allocation switching section 115 switches a signal point allocation by switching the multi-level signal 13, which is obtained by using the signal format A, to a multi-level signal, which is to be obtained by using the signal format B which is opposite in the polarity to the signal format A, and then outputs a resultant signal as a converted multi-level signal 23. In this manner, to switch a multi-level signal obtained by using a certain signal format to another multi-level signal obtained by using another certain signal format which is opposite in the polarity to the former certain signal format is herein after referred to as “to invert the polarity”. This inversion of the polarity is performed, in the first signal point allocation switching section 115, by setting an average level of the multi-level signal 13 as 0, multiplying the multi-level signal 13 by +1 or −1 in the case where a value of the switching random number 22 is “0” or “1”, respectively, adding an appropriate bias to a resultant multi-level signal 13, and then outputting a resultant signal as a converted multi-level signal 23. Further, in the case where the value of the inputted switching random number 22 is “0”, the first signal point allocation switching section 115 outputs the multi-level signal 13 as the converted multi-level signal 23 without inverting the polarity thereof. The modulator section 116 modulates the inputted converted multi-level signal 23 in a predetermined modulation method, and transmits a resultant signal as a modulated signal 14 to the transmission line 110.

Next, an operation of the receiving section 201 will be described. The demodulator section 211 performs photo-electric conversion of the modulated signal 14 transmitted via the transmission line 110, and outputs a resultant signal as a converted multi-level signal 33. In the same manner as the first switching random number generation section 114, the second switching random number generation section 214 generates a switching random number 32, which is a binary pseudo random number series, in accordance with the second switching key information 31. In the same manner as the first signal point allocation switching section 115, the second signal point allocation switching section 215 inverts the polarity of the converted multi-level signal 33 in the case where a value of the switching random number 32 is “1”, and does not invert the polarity of the converted multi-level signal 33 in the case where the value of the switching random number 32 is “0”, and then outputs a resultant signal as a multi-level signal 15.

In the same manner as the first multi-level code generation section 111 of the transmitting section 101, the second multi-level code generation section 212 generates a multi-level code sequence 17, which is a multi-level pseudo random number series having M digits of values from “0” to “M−1” (M is an integer of 2 or more) in accordance with the second key information 16, and also generates an inverted signal 35 which is a binary signal. When each of the values of the multi-level code sequence 17 is represented in a binary form, the inverted signal 35 corresponds to the lowest bit of each of the values. The decision section 216 determines, by using the signal format A shown in FIG. 2, a modulation pair corresponding to respective values constituting the multi-level code sequence 17 inputted from the second multi-level code generation section 212. The decision section 216 then performs binary decision in accordance with the determined modulation pair (a pair of levels) and the multi-level signal 15 inputted from the second signal point allocation switching section 215, performs the exclusive OR between a binary signal obtained by the binary decision and the inverted signal 35, and then outputs a result of the operation as information data 18 which is equal to the information data 10.

In the transmitting section 101, the multi-level processing section 113, the first switching random number generation section 114, the first signal point allocation switching section 115, and the modulator section 116 may be collectively regarded as a multi-level signal modulator section 112 which converts a multi-level signal obtained from the information data 10. In the receiving section 201, the second switching random number generation section 214, the second signal point allocation switching section 215, and the decision section 216 may be collectively regarded as a signal reproduction section 213 which obtains the information data 18 from the multi-level signal.

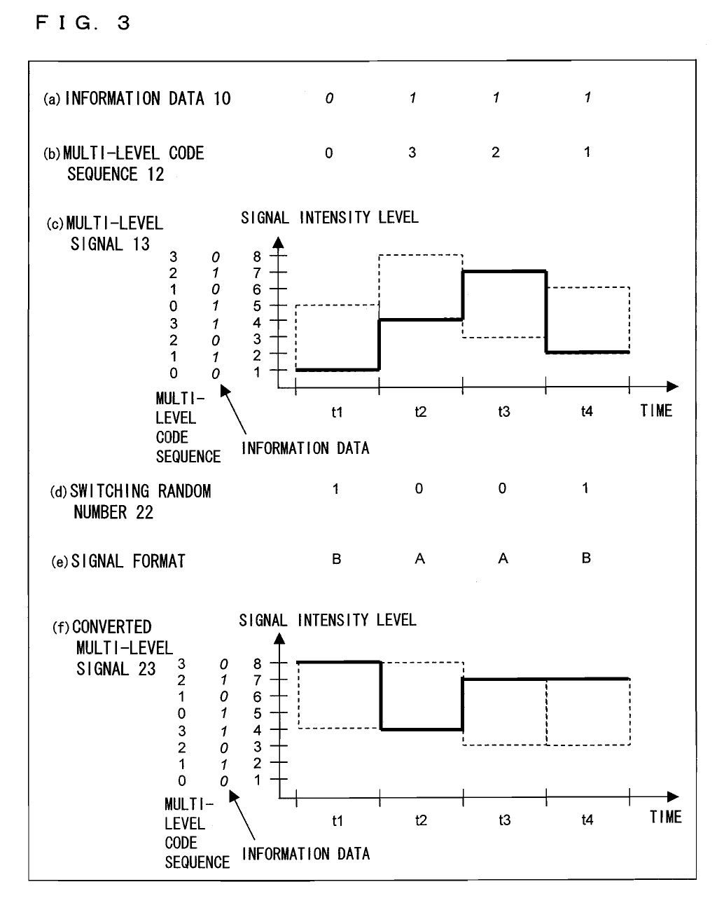

FIG. 3 is a diagram specifically illustrating the operation of the transmitting section 101 provided in the data communication apparatus 1. Hereinafter, by using an exemplary case where the modulated signal 14 is a light signal, and with reference to FIG. 3, a case where a value of the information data 10 changes “0 1 1 1” and a value of the multi-level code sequence 12 changes “0 3 2 1”, as with the description of the operation of the conventional transmitting/receiving apparatus shown FIG. 13, will be described. Here, the multi-level processing section 113 and the conventional multi-level processing section 912 perform identical processing to each other. Accordingly, the multi-level signal 13 (see FIG. 3(c)) and the conventional multi-level signal 93 (see FIG. 13(c)) are identical to each other, and thus description of the multi-level signal 13 will be omitted.

First, in the case where the values of the switching random number 22 are “1 0 0 1” (see FIG. 3(d)), the signal format used for generating the converted multi-level signal 23 is, as already described, “B A A B” (see FIG. 2 and FIG. 3(e)). Accordingly, as shown in FIG. 3(f), at each of the time periods t1 and t4 in which the signal format B is used, the converted multi-level signal 23 has the polarity inverted with respect to the multi-level signal 13 and the signal point allocation thereof is switched. As a result, the converted multi-level signal 23 has the signal level switched from 1 to 8, at the time period t1, and the signal level switched from 2 to 7, at the time period t4. The converted multi-level signal 23 is, as already described, converted by the modulator section 116 from an electric signal to the light signal (herein after referred to as an electric-photo conversion), and transmitted as a modulated signal 14.

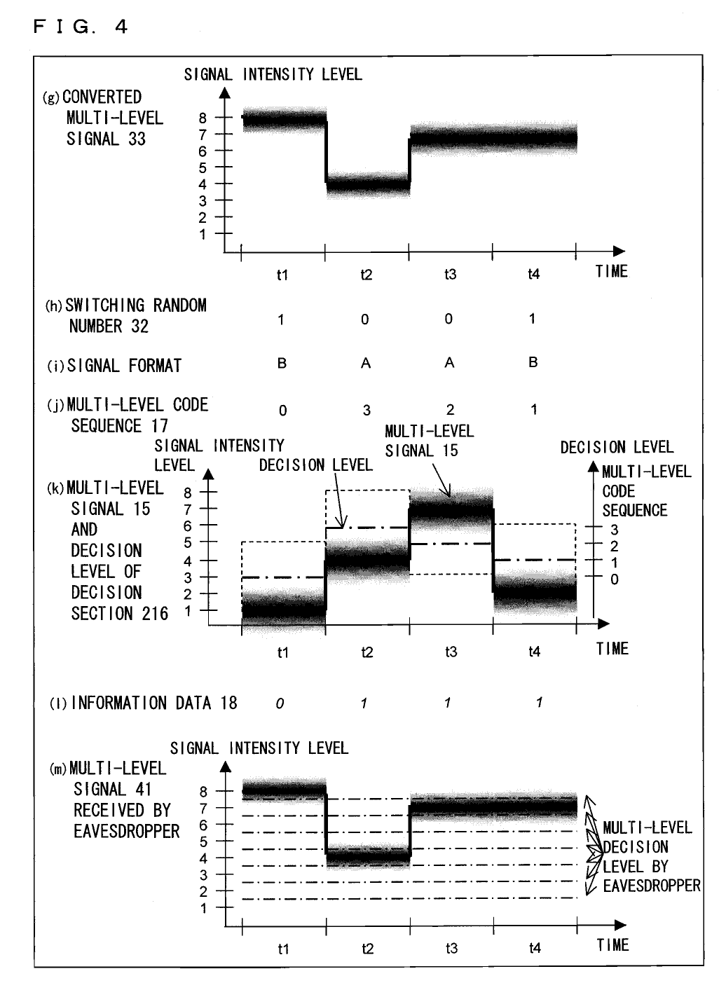

FIG. 4 is a diagram specifically illustrating the operation of the receiving section 201 provided in the data communication apparatus 1. The demodulator section 211 performs photo-electric conversion of the modulated signal 14 transmitted via the transmission line 110, and outputs a resultant signal as a modulated multi-level signal 33 including a noise such as a shot noise (see FIG. 4(g)). In accordance with the values “1 0 0 1” (see FIG. 4(h)) of the switching random number 32 which is equal to the switching random number 22, the second signal point allocation switching section 215 appropriately inverts the polarity of the converted multi-level signal 33 having been inputted, and then outputs a resultant signal as a multi-level signal 15 (see FIG. 4(k)). Specifically, the second signal point allocation switching section 215 inverts the polarity of the converted multi-level signal 33 at the time periods t1 and t4, and does not invert the polarity of the multi-level signal 33 at the time periods t2 and t3, and outputs a resultant signal as the multi-level signal 15. In the same manner as the conventional second multi-level code generation section 914, the second multi-level code generation section 212 generates, by using the second key information 16, the multi-level code sequence 17 “0 3 2 1” and the inverted signal 35 “0 1 0 1”, the multi-level code sequence 17 being a multi-level pseudo random number series equal to the multi-level code sequence 12. As with the processing performed by the conventional decision section 916 (see (d), (e), (f) of FIG. 13 and description thereof), the decision section 216 uses the multi-level code sequence 17 “0 3 2 1” inputted from the second multi-level code generation section 212, thereby performing binary decision (see (j) and (k) of FIG. 4) with respect to the multi-level signal 15 inputted from the second signal point allocation switching section 215, and also uses inverted signal 35 “0 1 0 1” inputted from the second multi-level code generation section 212, thereby obtaining information data 18 (see FIG. 4(l)), which is equal to the information data 10, from a binary signal “0 0 1 0” which indicates “low, low, high, low” and is obtained by the binary decision.

As with the description of the conventional receiving section 902 shown in FIG. 11, for example, in the case where a signal format, in which the value “1” of the information data is constantly allocated to the higher level of the modulation pair, and the value “0” of the information data is constantly allocated to the lower level of the modulation pair, is to be used, the decision section 216 does not need to use the inverted signal 35 so as to generate the information data 18.

Hereinafter, a case where eavesdropping (including interception) is to be performed will be described, with reference to FIG. 1 and FIG. 4(m). As described relating to the eavesdropping of the conventional transmitting/receiving apparatus, it is assumed that the eavesdropper uses the eavesdropping receiving section 301, reproduces the multi-level signal 13 from the modulated signal 14 without having the key information or the switching key information, and attempts decryption of the information data 10. The eavesdropping receiving section 301 is constituted of a demodulator section 311, a multi-level decision section 312, and a decryption processing section 313, and is connected to the transmission line 110.

In this case, as shown in FIG. 4(m), signal levels of a multi-level signal 41, which are obtained through the photo-electric conversion of the received modulated signal 14 performed by the demodulator section 311, distribute over several levels in the vicinity of a legitimate signal (the converted multi-level signal 23) due to an effect of the noise caused by quantum fluctuation.

Here, a case will be considered where the eavesdropper narrows down transition patterns of the multi-level signal which is determined depending on a characteristic of the pseudo random number generator used by the first multi-level code generation section 111 provided in the transmitting section 101, and extracts transition patterns, which exist in the vicinity of the level of the multi-level signal 41, among the narrowed down transition patterns, and then attempts identification of the first key information 11.

First, a case will be considered where the eavesdropper assumes that the signal format A is used for the multi-level signal 41. The signal format B used for the multi-level signal 41 at the time periods t1 and t4 is in an inverted relation (see FIG. 2), in terms of the polarity, with the signal format A which is used for the multi-level signal 41 at the time periods t2 and t3. Therefore, the polarity of the multi-level signal 41 at the time periods t1 and t4 is inverted with respect to the polarity of the multi-level signal 41 at the time periods t2 and t3. Accordingly, at each of the time periods t1 and t4, the multi-level signal 41 has a level which is significantly displaced from the multi-level signal 13, which is the legitimate signal. Therefore, at each of the time periods t1 and t4, the multi-level signal 41 takes a level which cannot be obtained from the correct first key information 11. As a result, the eavesdropper fails in narrowing down of the first key information 11, and thus decryption of the information data 10 is impossible.

Next, a case will be considered where the eavesdropper assumes that the signal format B is used for the multi-level signal 41. The multi-level signal 41 at the time periods t1 and t4 is in an inverted relation, in terms of the polarity, with the multi-level signal 41 at the time periods t2 and t3, in a similar manner. Accordingly, the multi-level signal 41 at each of the time periods t2 and t3 has a level significantly displaced from the multi-level signal 13, which is the legitimate signal. Therefore, the multi-level signal 41 takes a level which cannot be obtained from the correct first key information 11 at each of the time periods t2 and t3. As a result, in the same manner as the case where the signal format A is assumed to be used for the multi-level signal 41, the eavesdropper fails in the narrowing down of the first key information 11, and thus the decryption of the information data 10 is impossible.

Here, with reference to FIG. 5, another exemplary signal format in the first embodiment will be described. A signal format A1 is the same as the signal format A shown in FIG. 2. In the same manner as the signal format B shown in FIG. 2, a polarity of a signal format B1 is opposite to that of the signal format A1, and in addition, correspondence between a level and information data in the signal format B1 is displaced by one step width compared with the signal format B. Accordingly, with respect to common levels, a value of the information data corresponding thereto in the signal format B1 is different from a value of the information data corresponding thereto in the signal format A1. By using the signal format A1 and the signal format B1, the above-described narrowing down of the first key information 11 becomes further complicated and it also becomes impossible to attempt identification of the value of the information data 10 directly from the level. The inversion of the polarity, in the case where the signal format A1 and the signal format B1 are used, may be realized when the first signal point allocation switching section 115 adds a minute change, which is as minute as the step width, to the level in the case where the value of the switching random number 22 is “1”, in addition to the above-described multiplication processing.

The signal formats described with reference to FIGS. 2 and 5 are merely examples, and may be replaced with a signal format whose polarity can be inverted with respect to the multi-level signal 13. Further, the number of the signal formats to be used is not limited to two, but a configuration may be adopted in which three or more signal formats are used for switching the level. In this case, the first switching random number generation section 114 and the second switching random number generation section 214 generate a multi-level switching random number instead of the binary switching random number. Further, in FIGS. 3 and 4, a case where the multi-level number of the multi-level signal is eight is exemplified, however, the multi-level number is not limited to this, but may be replaced with any even number equal to or more than four. The key information and the switching key information retained by each of the transmitting section 101 and the receiving section 201 may be replaced with one piece of common key information. In this case, the common key information is inputted to the multi-level code generation section and the switching random number generation section which are both provided to the transmitting section and the receiving section.

As above described, in the data communication apparatus according to the first embodiment, a plurality of signal formats are used randomly, and the signal intensity level of the multi-level signal is displaced significantly. Accordingly, it becomes difficult to narrow down the key information by using the transition patterns of the level of the multi-level signal, and consequently security against the eavesdropping can be improved.

### Second Embodiment

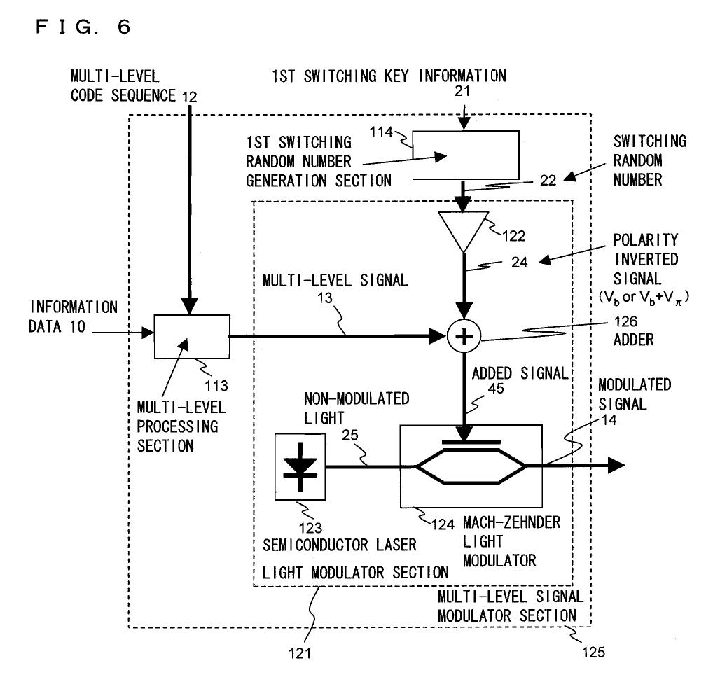

In a second embodiment, an example will be described in which the first signal point allocation switching section 115 and the modulator section 116, which are both provided to the multi-level signal modulator section 112 described in the first embodiment (see FIG. 1), are each replaced with a specific device. The other configurations excluding the multi-level signal modulator section 112 are the same as those described in the first embodiment, and thus description thereof will be omitted. FIG. 6 is a diagram showing an exemplary configuration of a multi-level signal modulator section 125 according to the second embodiment of the present invention. As shown in FIG. 6, the multi-level signal modulator section 125 includes the multi-level processing section 113, the switching random number generation section 114, and a light modulator section 121. The light modulator section 121 is constituted of a polarity inverted signal generation section 122, a semiconductor laser 123, a Mach-Zehnder light modulator 124, and an adder 126.

Hereinafter, with reference to FIG. 6, operations of respective units constituting the light modulator section 121 will be described in detail. Description of the multi-level processing section 113 and the first switching random number generation section 114 is performed in the first embodiment, and thus will be omitted here. The polarity inverted signal generation section 122 outputs a polarity inverted signal 24 having two predetermined voltage levels corresponding to values of the switching random number 22 inputted from the first switching random number generation section 114. The semiconductor laser 123 outputs a non-modulated light 25. The adder 126 adds the multi-level signal 13 inputted from the multi-level processing section 113 and the polarity inverted signal 24 inputted from the polarity inverted signal generation section 122, and then outputs an added signal 45. The Mach-Zehnder light modulator 124 modulates the non-modulated light 25 inputted from the semiconductor laser 123 by using the added signal 45 inputted from the adder 126, and outputs a resultant modulated signal 14.

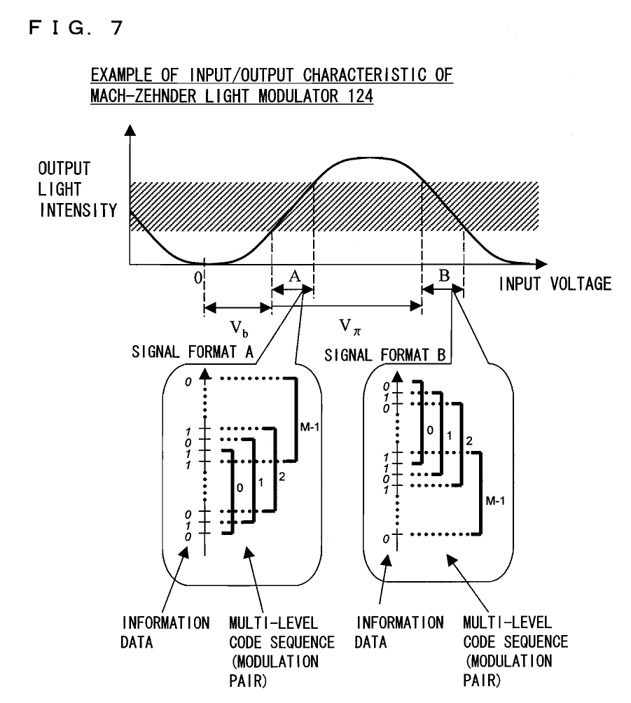

Here, the Mach-Zehnder light modulator 124 generally has a periodic input/output characteristic as shown in FIG. 7. Specifically, output light intensity changes in a sinusoidal manner in proportion to an increase in an input voltage. Accordingly, the input/output characteristic is such that the output light intensity increases in a certain range in proportion to the increase in the input voltage, and the output light intensity decreases in another certain range in proportion to the increase in the input voltage. Therefore, a bias voltage to be applied to the Mach-Zehnder light modulator 124 is switched in an appropriate manner in accordance with the switching random number 22, whereby a polarity of the multi-level signal 13 is inverted appropriately, and electric-photo conversion is performed with respect to the multi-level signal obtained by inverting the polarity thereof. Accordingly, a resultant modulated signal 14 is outputted.

Specifically, light modulator section 121 selects two operation ranges of the Mach-Zehnder light modulator 124 (see A and B in FIG. 7). In the two operation ranges, the output light intensity changes substantially linearly with respect to the input voltage, and increase/decrease in the output light intensity in proportion to the increase in the input voltage shows an opposite relation. Further, levels of the output light intensity in the two operation ranges are identical to each other. The light modulator section 121 sets a voltage amplitude of the multi-level signal 13 to the same voltage width as these operation ranges, and also sets two voltages of the polarity inverted signal, the voltages corresponding to the bias voltage, to V_{b} and V_{b}+Vπ, respectively, which are lower limits of input voltages to the two operation ranges. Here, Vπ is a half wavelength voltage of the Mach-Zehnder light modulator 124. Accordingly, the light modulator section 121 is capable of generating the modulated signal 14 constituted of a modulated signal which is obtained by performing the electric-photo conversion of the multi-level signal based on the signal format A and a modulated signal which is obtained by performing electric-photo conversion of the multi-level signal based on the signal format B (see FIG. 2). When a difference between the two voltage levels of the polarity inverted signal 24 is set smaller than the half wavelength voltage Vπ by a voltage level corresponding to the step-width, the signal formats A1 and B1 shown in FIG. 5 may be also used for the transmitting section 101 and the receiving section 201.

A signal mode and an effect on the eavesdropping in the second embodiment are the same as those described in the first embodiment with reference to FIGS. 3 and 4, and thus description thereof will be omitted.

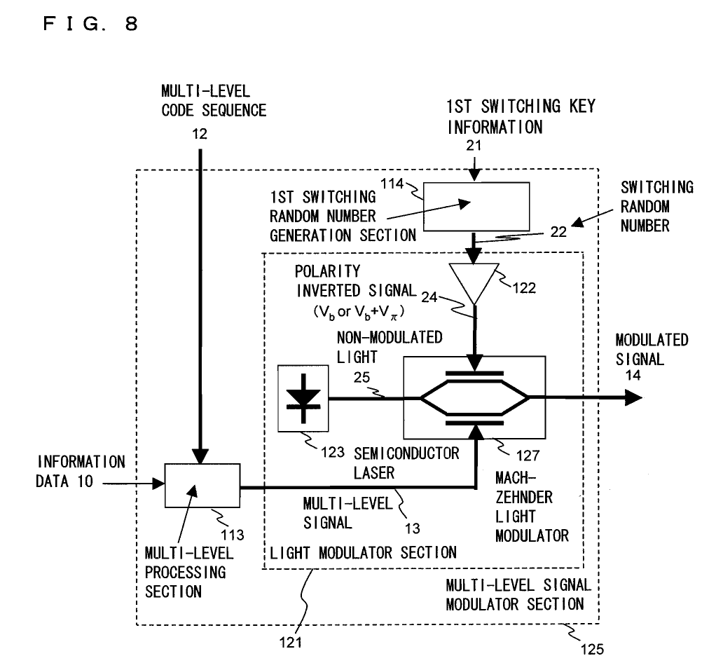

There is a type of the Mach-Zehnder light modulator which is capable of performing modulation individually in two channels of an internal interferometer provided therein. In the case where this type of the Mach-Zehnder light modulator 127 is used, it is possible to configure the light modulator section 121 as shown in FIG. 8. In other words, Mach-Zehnder light modulator 127 has two electrodes corresponding to the two channels of the internal interferometer. The multi-level signal 13 is inputted to one of the electrodes, and the polarity inverted signal 24 is inputted to the other of the electrodes. Accordingly, the adder 126 for adding the multi-level signal 13 and the polarity inverted signal 24 becomes unnecessary.

In the above-described configuration, the two electrodes of the Mach-Zehnder light modulator 127 are in the opposite relation to each other with respect to the increase/decrease in the output light intensity (output signal intensity) in proportion to the increase in the input voltage. Therefore, the level V_{b} Of the polarity inverted signal 24 corresponds to an operation range B shown in FIG. 7, and the level V_{b}+Vπ thereof corresponds to an operation range A shown in FIG. 7. Other relations relating to the input/output characteristic are the same as those already described with reference to FIG. 7.

According to the input/output characteristic shown in FIG. 7, a case is described where the output light intensity becomes “0” when the input voltage is “0”. However, the input voltage, in the case where the output light intensity is actually “0”, varies depending on the light modulator. Therefore, the fixed bias level V_{b} needs to be set appropriately in accordance with the light modulator to be used. With reference to FIGS. 6 and 8, a case is described where the fixed bias level V_{b} is included in the polarity inverted signal 24. However, the fixed bias level V_{b} may be added to the multi-level signal 13, and the level of the polarity inverted signal 24 may be set to 0 and Vπ. Further, FIGS. 6 and 8 each shows the configuration in which the Mach-Zehnder light modulator is used. However, the light modulator section 121 may be configured with an element whose input/output characteristic satisfies the following conditions.

1. The element has at least two different input level ranges which respectively correspond to outputs of a common level.
2. The at least two input level ranges show opposite increase/decrease characteristics of the corresponding outputs in proportion to the increases in the inputs.

As above described, in the data transmitting apparatus and the data receiving apparatus (the data communication apparatus) according to the second embodiment, the light modulator for modulating a light signal is used, whereby the first signal point allocation switching section 115 and the modulator section 116 of the first embodiment may be collectively replaced with the light modulator section 121. As a result, particularly in the case where the light signal is modulated by using the light modulator which is an external component part, the number of component parts to be added may be minimized, and an effect in improving security against eavesdropping can be obtained in the same manner as the first embodiment.

### Third Embodiment

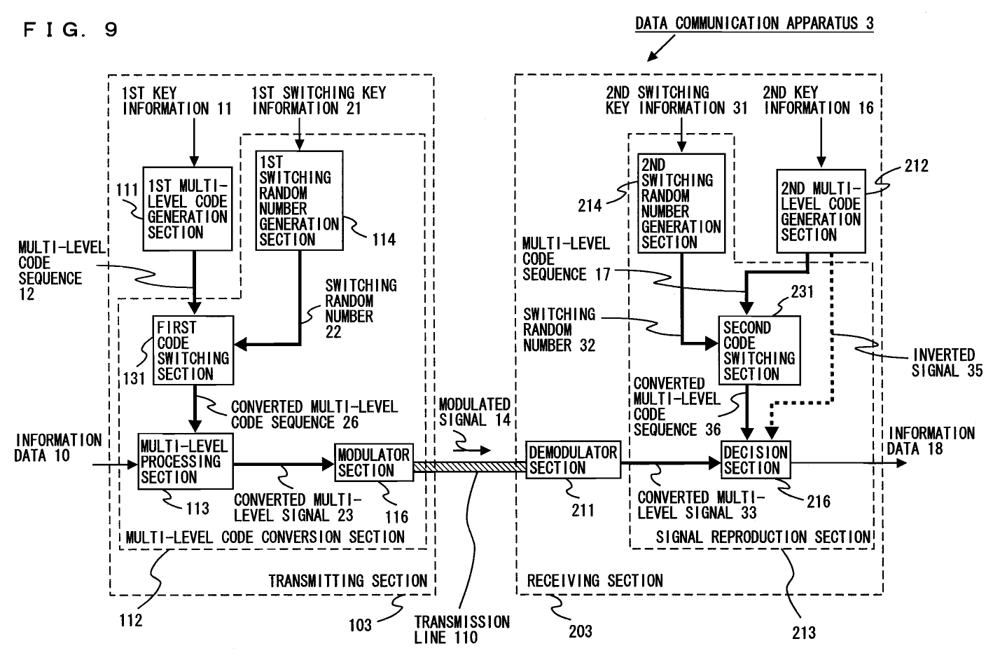

FIG. 9 is a block diagram showing an exemplary configuration of a data communication apparatus 3 according to a third embodiment of the present invention. Here, the data communication apparatus 1 of the first embodiment switches a signal point allocation of the multi-level signal 13 outputted by the multi-level processing section 113, thereby generating the converted multi-level signal 23 in which the signal point allocation is switched. On the other hand, a data communication apparatus 3 converts the multi-level code sequence 12 and inputs the resultant signal to the multi-level processing section 113, thereby generating the converted multi-level signal 23 in which the signal point allocation is switched. As shown in FIG. 9, the data communication apparatus 3 has a configuration in which a data transmitting apparatus (herein after referred to as a transmitting section) 103 and a data receiving apparatus (herein after referred to as a receiving section) 203 are connected to each other via the transmission line 110. The transmitting section 103 includes the first multi-level code generation section 111, the multi-level processing section 113, the first switching random number generation section 114, a first code switching section 131, and the modulator section 116. The receiving section 203 includes the demodulator section 211, the second multi-level code generation section 212, the second switching random number generation section 214, a second code switching section 231, and the decision section 216. In the third embodiment, components parts described in the first embodiment will be each provided a common reference character, and description thereof will be omitted.

First, an operation of the transmitting section 103 will be described. As shown in FIG. 9, to the first code switching section 131, a multi-level code sequence 12 is inputted from the first multi-level code generation section 111, and in the case where the value of a switching random number 22 inputted from the first switching random number generation section 114 is “0”, a code of the multi-level code sequence 12 is not switched, whereas in the case where the value of the switching random number 22 is “1”, the code of the multi-level code sequence 12 is switched as described hereinbelow (by switching a coding rule), and then outputs a resultant converted multi-level code sequence 26.

An operation of the first code switching section 131 will be described in detail in the case where the number of multi levels of the multi-level code sequence 12 is M (the multi-level code sequence takes 0 to M−1 values). In the case where the value of the inputted switching random number 22 is “1”, the first code switching section 131 determines a value of the converted multi-level code sequence 26 such that a sum between the value of the multi-level code sequence 12 and the value of the converted multi-level code sequence 26 is M−1. In the case where the value of the inputted switching random number 22 is “0”, the first code switching section 131 uses the value of the multi-level code sequence 12 as the value of the converted multi-level code sequence 26. In other words, in the case where the value of the switching random number 22 is “1”, the first code switching section 131 sets the converted multi-level code sequence 26 such that the sum between the value of the multi-level code sequence 12 and the value of the converted multi-level code sequence 26 is constantly equal to a sum between a maximum value and a minimum value of the multi-level code sequence 12. Accordingly, in the same manner as the first signal point allocation switching section 115 of the first embodiment, the multi-level processing section 113 of the third embodiment is capable of generating the converted multi-level signal 23 in which the signal point allocation is switched in accordance with the switching random number 22. For example, in the case where the multi-level code sequence 12 is constituted of four values of “0 3 2 1”, and the switching random number 22 is constituted of “1 0 0 1” (see (b) and (d) of FIG. 3), the converted multi-level code sequence 26 comes to “3 3 2 2”. The multi-level processing section 113 interrelates the values “0 1 1 1” of the information data 10 with the values “3 3 2 2” of the converted multi-level code sequence 26 in accordance with a predetermined procedure described in the first embodiment, by using a signal format A shown in FIG. 2, and then generates the converted multi-level signal 23 constituted of values of “8 4 7 7” (see (a) and (f) of FIG. 3).

Next, an operation of the receiving section 203 will be described. As shown in FIG. 9, the second code switching section 231 performs code conversion of the inputted multi-level code sequence 17 by using the value of the switching random number 32, in accordance with the same procedure as the first code switching section 131, and then outputs a converted multi-level code sequence 36 which is equal to the converted multi-level code sequence 26. By using the inputted converted multi-level code sequence 36, the decision section 216 performs decision (binary decision) of the converted multi-level signal 33 in accordance with a predetermined procedure described in the first embodiment, and obtains information data 18 in accordance with a result of the decision and the inverted signal 35 having been inputted.

As with the description of the conventional receiving section 902 shown in FIG. 11, for example, when a signal format is used, in which the value “1” of the information data is constantly allocated to a higher level of a modulation pair, and the value “0” of the information data is constantly allocated to a lower level thereof, then the decision section 216 does not need to use the inverted signal 35 for generating the information data 18.

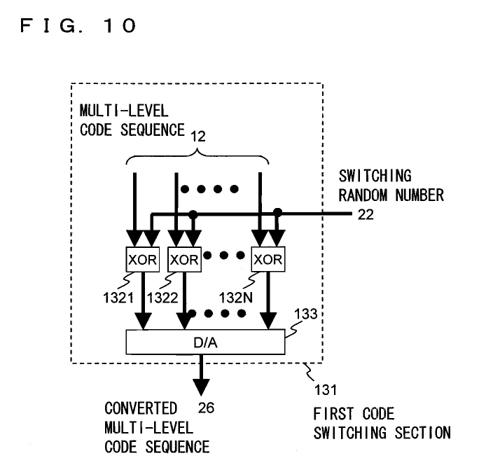

The operations (configurations) of the first code switching section 131 and the second code switching section 231 vary depending on the signal mode of the multi-level code sequence 12 (or the multi-level code sequence 17). In the case where the multi-level code sequence 12 is a multi-level serial signal, the first code switching section 131 regards an average level of the multi-level code sequence 12 as 0, multiplies the value of the multi-level code sequence 12 by +1 or −1 in the case where the value of the switching random number 22 is “0” or “1”, respectively, adds an appropriate bias thereto, and then outputs a resultant converted multi-level code sequence 26. The second code switching section 231 also performs a similar operation. On the other hand, in the case where the multi-level code sequence 12 is a binary parallel signal, the first code switching section 131 is configured as shown in FIG. 10. In this case, the first code switching section 131 is configured with exclusive OR circuits 1321 to 132N, the number of which corresponds to the number of bits of respective values constituting the multi-level code sequence 12, and a D/A conversion section 133. To each of the exclusive OR circuits 1321 to 132N, each of the bits of the respective values constituting the multi-level code sequence 12 and the switching random number 22 are inputted, and a result of an exclusive OR operation is outputted therefrom. The D/A conversion section 133 has the result of the exclusive OR operation inputted thereto, performs D/A conversion of the result, and outputs a converted multi-level code sequence. The second code switching section 231 also has a similar configuration.

As above described, the data communication apparatus according to the third embodiment has a configuration different from the data communication apparatus according to the first embodiment, but is capable of exerting the same effect as the data communication apparatus according to the first embodiment.

While the invention has been described in detail, the foregoing description is in all aspects illustrative and not restrictive. It is understood that numerous other modifications and variations can be devised without departing from the scope of the invention.

What is claimed is:

1. A data transmitting apparatus for causing information data to have multi levels by using predetermined key information and performing secret communication with a receiving apparatus, comprising:
a multi-level code generation section for generating, by using the predetermined key information, a multi-level code sequence in which a value changes so as to be approximately random numbers; and
a multi-level signal modulator section for generating a converted multi-level signal in accordance with information shared with the receiving apparatus, the multi-level code sequence and the information data, modulating the converted multi-level signal in a predetermined modulation method, and outputting a resultant modulated signal, wherein
the converted multi-level signal is a signal having a plurality of signal point allocations which are different from one another, and
the multi-level signal modulator section switches the plurality of signal point allocations of the converted multi-level signal in accordance with the information shared with the receiving apparatus.

2. The data transmitting apparatus according to claim 1, wherein
the plurality of signal point allocations includes at least a first signal point allocation and a second signal point allocation each having a plurality of signal levels corresponding to the multi-level code sequence, and
the first signal point allocation and the second signal point allocation respectively have polarities which are mutually in an inverted relation, the polarities each representing an ascending/descending order of the plurality of signal levels corresponding to the multi-level code sequence.

3. The data transmitting apparatus according to claim 2, wherein
the first signal point allocation is formed based on a first signal format,
the second signal point allocation is formed based on a second signal format,
the first signal format and the second signal format:
each represents a signal format which allows values of the information data and the plurality of signal levels to be allocated to the multi-level code sequence; and
are mutually in an inverted relation concerning an ascending/descending order of the multi-level code sequence corresponding to the plurality of signal levels.

4. The data transmitting apparatus according to claim 3, wherein in the first signal format and the second signal format, common signal levels are allocated to different values of the information data.

5. The data transmitting apparatus according to claim 3, wherein
the multi-level signal modulator section includes:
a multi-level processing section for generating a multi-level signal by using the information data and the multi-level code sequence in accordance with the first signal format;
a switching random number generation section for generating a switching random number, which is constituted of binary random numbers, by using switching key information which is the information shared with the receiving apparatus;
a signal point allocation switching section for switching, in accordance with the switching random number, the multi-level signal to a multi-level signal based on the second signal format, and outputting a resultant converted multi-level signal; and
a modulator section for modulating the converted multi-level signal, and outputting a resultant modulated signal.

6. The data transmitting apparatus according to claim 3, wherein
the multi-level signal modulator section includes:
a multi-level processing section for generating a multi-level signal by using the information data and the multi-level code sequence in accordance with the first signal format;
a switching random number generation section for generating a switching random number, which is constituted of binary random numbers, by using switching key information which is the information shared by the receiving apparatus; and
a light modulator section for switching the multi-level signal, which is an electrical signal, to a multi-level signal partially based on the second signal format in accordance with the switching random number, and for modulating a resultant signal into a modulated signal which is a light signal,
the light modulator section:
has at least two different input level ranges respectively corresponding to output level ranges of a common level, the at least two different input level ranges showing opposite increase/decrease characteristics of the corresponding output level ranges in proportion to increases in respective inputs; and
uses the two input level ranges in a switched manner in accordance with the switching random number.

7. The data transmitting apparatus according to claim 6, wherein
the light modulator section includes:
a polarity inverted signal generation section for converting the switching random number to a polarity inverted signal having two different voltage levels;
a semiconductor laser for outputting a non-modulated light; and
a Mach-Zehnder light modulator for modulating the non-modulated light by using the multi-level signal and the polarity inverted signal and outputting a resultant modulated signal, and
the multi-level signal is switched to a multi-level signal based on the second signal format by approximately equating a difference between the two voltage levels of the polarity inverted signal with a half wavelength voltage of the Mach-Zehnder light modulator.

8. The data transmitting apparatus according to claim 7, wherein the multi-level signal and the polarity inverted signal are combined together, and inputted to a single modulating electrode of the Mach-Zehnder light modulator.

9. The data transmitting apparatus according to claim 7, wherein
the Mach-Zehnder light modulator has two modulating electrodes corresponding to respective channels of an interferometer provided thereinside, and
the multi-level signal is inputted to one of the two modulating electrodes, and the polarity inverted signal is inputted to the other of the two modulating electrodes.

10. The data transmitting apparatus according to claim 2, wherein
the multi-level signal modulator section includes:
a switching random number generation section for generating a switching random number, which is constituted of binary random numbers, by using switching key information which is the information shared with the receiving apparatus;
a code switching section for converting a code of the multi-level code sequence in accordance with the switching random number, and outputting a resultant converted multi-level code sequence;
a multi-level processing section for generating, by using the information data and the converted multi-level code sequence, the converted multi-level signal, in accordance with a signal format in which values of the information data and the plurality of signal levels are allocated to the converted multi-level code sequence; and
a modulator section for modulating the converted multi-level signal in a predetermined modulation method, and outputting a resultant modulated signal, and
when the code of the multi-level code sequence is converted, sums between respective values constituting the multi-level code sequence and respective values constituting the converted multi-level code sequence are each constantly equal to a sum between a maximum value and a minimum value of the multi-level code sequence.

11. The data transmitting apparatus according to claim 10, wherein
the multi-level code sequence is a binary parallel signal,
the code switching section includes:
exclusive OR circuits whose number is equal to a number of bits of the respective values constituting the multi-level code sequence; and
a D/A conversion section for collectively performing D/A conversion of output signals from the exclusive OR circuits, and outputting the converted multi-level code sequence, and
the exclusive OR circuits each performs an exclusive OR operation between respective bits of the respective values constituting the multi-level code sequence and the switching random number, and outputs a result thereof.

12. A data receiving apparatus for reproducing, by using predetermined key information, information data from a modulated signal having been received, and performing secret communication with a transmitting apparatus, comprising:
a multi-level code generation section for generating, by using the predetermined key information, a multi-level code sequence in which a value changes so as to be approximately random numbers;
a demodulator section for demodulating the modulated signal and outputting a converted multi-level signal; and
a signal reproducing section for reproducing the information data in accordance with information shared with the transmitting apparatus, the multi-level code sequence and the converted multi-level signal, wherein
the converted multi-level signal is a signal having a plurality of signal point allocations which are different from one another, and
the signal reproducing section switches the plurality of signal point allocations of the converted multi-level signal in accordance with the information shared with the transmitting apparatus.

13. The data receiving apparatus according to claim 12, wherein
the plurality of signal point allocations includes at least a first signal point allocation and a second signal point allocation each having a plurality of signal levels corresponding to the multi-level code sequence, and
the first signal point allocation and the second signal point allocation respectively have polarities which are mutually in an inverted relation, the polarities each representing an ascending/descending order of the plurality of signal levels corresponding to the multi-level code sequence.

14. The data receiving apparatus according to claim 13, wherein
the first signal point allocation is formed based on a first signal format,
the second signal point allocation is formed based on a second signal format,
the first signal format and the second signal format:
each represents a signal format which allows values of the information data and the plurality of signal levels to be allocated to the multi-level code sequence, and
are mutually in an inverted relation concerning an ascending/descending order of the multi-level code sequence corresponding to the plurality of signal levels.

15. The data receiving apparatus according to claim 14, wherein in the first signal format and the second signal format, common signal levels are allocated to different values of the information data.

16. The data receiving apparatus according to claim 14, wherein
the signal reproducing section includes:
a switching random number generation section for generating a switching random number, which is constituted of binary random numbers, by using switching key information which is the information shared with the transmitting apparatus;
a signal point allocation switching section for switching the converted multi-level signal to a signal based on the first signal format in accordance with the switching random number, and outputting a resultant multi-level signal; and
a decision section for performing binary decision of the multi-level signal in accordance with the multi-level code sequence, and outputting a resultant signal as the information data.

17. The data receiving apparatus according to claim 13, wherein
the signal reproducing section includes:
a switching random number generation section for generating a switching random number, which is constituted of binary random numbers, by using switching key information which is the information shared with the transmitting apparatus;
a code switching section for converting a code of the multi-level code sequence in accordance with the switching random number, and outputting a resultant converted multi-level code sequence; and
a decision section for performing, by using the converted multi-level code sequence, binary decision of the converted multi-level signal in accordance with a signal format in which values of the information data and the plurality of signal levels are allocated to the converted multi-level code sequence, and
when the code of the multi-level code sequence is converted, sums between respective values constituting the multi-level code sequence and respective values constituting the converted multi-level code sequence are each constantly equal to a sum between a maximum value and a minimum value of the multi-level code sequence.

18. The data receiving apparatus according to claim 17, wherein
the multi-level code sequence is a binary parallel signal,
the code switching section includes:
exclusive OR circuits whose number is equal to a number of bits of the respective values constituting the multi-level code sequence; and
a D/A conversion section for collectively performing D/A conversion of output signals from the exclusive OR circuits, and outputting the converted multi-level code sequence, and
the exclusive OR circuits each performs an exclusive OR operation between respective bits of the respective values constituting the multi-level code sequence and the switching random number and outputs a result thereof.

19. A light modulator apparatus for modulating a multi-level signal, which is an electric signal having a plurality of levels, to a modulated signal, which is an optical signal, in accordance with a switching random number which is constituted of binary random numbers, wherein:
the light modulator apparatus has at least two different input level ranges respectively corresponding to output level ranges of a common level;
the at least two different input level ranges show opposite increase/decrease characteristics of the corresponding output level ranges in proportion to increases in respective inputs; and
the at least two different input levels ranges are used in a switched manner in accordance with the switching random number.

20. The light modulator apparatus according to claim 19, comprising:
a polarity inverted signal generation section for converting the switching random number to a polarity inverted signal having two different voltage levels;
a semiconductor laser for outputting a non-modulated light; and
a Mach-Zehnder light modulator for modulating the non-modulated light by using the multi-level signal and the polarity inverted signal, and outputting a resultant modulated signal, wherein
signal point allocation of the multi-level signal is switched by approximately equating a difference between the two voltage levels of the polarity inverted signal with a half wavelength voltage of the Mach-Zehnder light modulator.

21. The light modulator apparatus according to claim 20, wherein the multi-level signal and the polarity inverted signal are combined together, and inputted to a single modulating electrode of the Mach-Zehnder light modulator.

22. The light modulator apparatus according to claim 20, wherein
the Mach-Zehnder light modulator has two modulating electrodes corresponding to respective channels of an interferometer provided thereinside, and
the multi-level signal is inputted to one of the two modulating electrodes, and the polarity inverted signal is inputted to the other of the two modulating electrodes.

23. A data transmitting method for causing information data to have multi levels by using predetermined key information and performing secret communication with a receiving apparatus, comprising the steps of:
generating, by using the predetermined key information, a multi-level code sequence in which a value changes so as to be approximately random numbers; and
generating a converted multi-level signal in accordance with information shared with the receiving apparatus, the multi-level code sequence and the information data, modulating the converted multi-level signal in a predetermined modulation method, and outputting a resultant modulated signal, wherein
the converted multi-level signal is a signal having a plurality of signal point allocations which are different from one another, and
the plurality of signal point allocations of the converted multi-level signal are switched in accordance with the information shared with the receiving apparatus.

24. A data receiving method for reproducing, by using predetermined key information, information data from a modulated signal having been received and performing secret communication with a transmitting apparatus, comprising the steps of:
generating, by using the predetermined key information, a multi-level code sequence in which a value changes so as to be approximately random numbers;
demodulating the modulated signal and outputting a converted multi-level signal; and
reproducing the information data in accordance with the information shared with the transmitting apparatus, the multi-level code sequence and the converted multi-level signal, wherein
the converted multi-level signal is a signal having a plurality of signal point allocations which are different from one another, and
the plurality of signal point allocations of the converted multi-level signal are switched in accordance with the information shared with the transmitting apparatus.
